(19) United States
(12) Patent Application Publication
(10) Pub. No.: US 2008/0015988 A1
(43) Pub. Date: Jan. 17, 2008

(54) PROXY CARD AUTHORIZATION SYSTEM

(76) Inventors: Gary Brown, Hertfordshire (GB); Stephen Ross-Talbot, West Sussex (GB)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/770,521

(22) Filed: Jun. 28, 2007

Related U.S. Application Data
(60) Provisional application No. 60/806,062, filed on Jun. 28, 2006.

(51) Int. Cl. G06Q 40/00; G06K 19/00

(52) U.S. Cl. 705/44

(57) ABSTRACT

A system and method is provided for providing proxy access to a set of resources subject to constraints specified by the primary party having access to the resources. The system comprises one or more proxy cards associated with a proxy account that contains details on the resources available and also configurable rules for processing proxy authorization requests and returning an authorization response in dependence on the rules. The system has a particular application to payment cards and accounts, whereby the proxy card can act as proxy for one or more of the real payment cards and the proxy card authentication service may operate in a transparent manner as part of a normal overall payment authorization process.

### CROSS-REFERENCE TO RELATED APPLICATIONS

This application claims the benefit of U.S. Provisional Application Ser. No. 60/806,062, filed Jun. 28, 2006, which is incorporated herein by reference.

### FIELD OF THE INVENTION

The present invention relates to payment cards and payment authorization systems and in particular to a proxy card authorization system.

### BACKGROUND TO THE INVENTION

Credit and debit cards have been available for many years, and provide the means for a customer to obtain cash or buy goods by presenting a merchant (in person, over the telephone or via the web) a card (or card details), which is then authorized to determine whether the transaction should be permitted.

The authorization procedure has evolved over the years, but essentially involves the merchant making the authorization request via their acquirer to a Card Authority (e.g. VISA or Mastercard). This authority then determines which Card Issuer is associated with the card, based on the first set of digits of the card account number. An authorization request is then forwarded to the Card Issuer for final authorization. The result of the authorization is subsequently returned back to the merchant, to determine whether the transaction was successful or not.

The current level of authorization provided by the Card Issuer is limited, and is primarily based on whether the account to which the card is associated has enough funds (or credit). More recent advances in fraud detection employ methods to determine whether the transaction may be invalid based on other properties, such as the user's spending patterns or location. For example, a person cannot be physically presenting the card in two different geographical locations within a certain time frame.

However, current credit and debit cards have a restriction in that they only permit the actual account holder associated with the credit/debit card to make use of that card. Although this is often necessary for obvious security reasons, it does make it difficult for some people to make use of the security benefits that such cards can offer. For example, elderly or disabled people, who are generally confined to their homes, typically rely on other people to buy items for them. The only way they can do this currently is by using cash, which means they are obliged to keep cash around the house, making them an easy target for criminals. Although using a credit/debit card would be one solution, this is currently not possible due to contractual obligations undertaken when a customer signs up for such a card. If the customer was knowingly to allow other people to use their credit/debit card, then the card owner would be directly liable for any losses that result.

As such, there is need for a payment system whereby a person other than a primary card holder can be authorised to make use of a card and associated account, but which is not open to abuse by the other person and which still offers a secure transaction mechanism for all parties involved.

### SUMMARY OF THE INVENTION

According to a first aspect of the present invention there is provided a proxy card associated with a proxy account, the proxy account comprising details of one or more resources to which a first party has access, wherein access to one or more of the resources by a second party is in dependence on the proxy card and is governed by authorization rules, the rules being preconfigured by the first party.

Generally, the first party and the second party will be different, although there are circumstances where they may be the same.

Typically, there will be a plurality of resources registered with the proxy account and to which, in principle, the second party may be granted access. In this way, the proxy card may act as proxy for the access mechanism to these resources.

As proxy account holder, the first party can exercise control over which resources may be accessed by the second party through configuration of the authorization rules. In order to gain access to one or more of the potentially available resources, the second party must present the proxy card or provide details associated with it, for example the proxy card number.

There may be more than one proxy card associated with the proxy account, the cards being issued to the second and possibly other parties. Alternatively, each card may be associated with a separate proxy account, which permits access to the first party's resources subject to authorization rules specified by the first party.

Preferably, at least one of the resources comprises a bank account or credit card account in the name of the first party. In this case, the second party presenting the proxy card will be able to access facilities associated with the bank account or credit card account, including debit and credit facilities, depending upon the precise authorization rules set by the first party, who is also the named primary bank account or credit card account holder.

In effect, the proxy card may become associated with a payment card, such as a debit card or credit card, owned by the primary holder of the corresponding account, and thereby act as proxy for it. Again, the presenter of the proxy card and the primary account holder will, in general, be different parties, but under some circumstances they may the same party.

The proxy account may comprise details of several such payment cards. In this case, the owner of the cards, i.e. the first party, may configure rules to route specific transactions to the different cards. The first party may also create “card groups comprising a plurality of preselected cards. In this case the first party may configure authorization rules to govern how a transaction or transactions are distributed over the cards within the group. For example, the rules may define a hierarchy for a card group that governs the order in which payment cards within the group should be used to pay for a given transaction or transactions, subject to the available line of credit.

The authorization rules may govern access to the resource on the basis of a whole range of criteria. For example, rules associated with a proxy card may restrict its usage based on the merchant type or specific merchant identification, a particular time period, the geographical location of second party presenting the proxy card, the amount of a given transaction, the number of transactions within a time period, or any combination of these constraints. Any information that is explicitly available within an authorization request, or that can be derived from information contained in the request, is a suitable property on which to apply a constraint. Thus, the first party may configure authorization rules so as to give rise to a highly complex interrelated rules structure governing usage of the proxy card and access to potential resources.

Although, the resource available to the first party will typically be an account providing a line of credit in some manner, the proxy card may also be used to permit the second party presenting the proxy card to access other types of service or to act on behalf of the first party, subject to configurable authorization rules. In this way, the party presenting the proxy card may demonstrate that he/she has the legal proxy of the first party and may act accordingly.

According to a second aspect of the present invention, a method for governing access by a second party to one or more resources available to a first party comprises the steps of:

receiving a request for authorization to access the one or more resources in dependence on a proxy card;

determining whether the one or more resources are associated with the proxy card;

applying authorization rules to determine whether access to the one or more resources should be granted, the rules having been preconfigured by the first party; and

transmitting a reply indicating whether authorization to access the one or more resources has been granted.

In this way, a second party presenting a proxy card or associated card details (card number, for example) may be granted access to one or more resources available to a first party, but subject to authorization rules specified by the first party. The method will typically be performed by a proxy card issuer, thereby providing a proxy card authorization service. Preferably, the method further comprises associating the proxy card with a proxy account in the name of the first party. The proxy account may comprise details of the resources available to the first party and which may be accessible to the second party presenting the proxy card or associated card details.

Preferably, the method further comprises authenticating the first party. The identity of the first party may be authenticated in dependence on personal details, which may include full name, address, date of birth, and social security number or equivalent (e.g. national insurance (NI) number).

The method may also further comprises authenticating the second party presenting the proxy card. The second party may also be authenticated in dependence on data associated with the first party. Typically, the second party will be authenticated via a security feature associated with the proxy card, implemented using technologies such as “chip and pin”.

The authorization request may originate from a merchant or vendor in response to being presented with the proxy card or associated details by the second party. Typically, the request will be a payment authorization request to facilitate payment for goods or services purchased by the second party, the payment actually debited to a payment account in the name of the first party. In this case, the proxy card may be, in effect, a proxy for an actual payment card owned by the first party.

Once the rules have been applied, it may be possible to directly authorize access to the resource. Alternatively, further authorization may be required.

Preferably, the method further comprises the steps of:

forwarding the received authorization request to a third party authorization service; and,

receiving from the third party authorization service a reply indicating whether authorization to access at least one of the resources has been granted,

and wherein the step of transmitting a reply indicating whether authorization to access the one or more resources has been granted is performed in dependence on the reply received from the third party authorization service.

The third party authorization service will typically only be able to authorize access to certain resources and requests for access to other resources must be forwarded to another third party authorization service capable of authorizing access to these.

This additional authorization step will typically be required when the resource to be accessed is some form of payment account. The third party authorization service may then be provided by the relevant card authority or card issuer associated with a payment card for the account. In this case, the proxy card authentication service provided by or for the proxy card issuer will operate as part of the overall normal payment authorization process, but will do so in a transparent manner.

Where third party authorization is required, it will typically be necessary for some form of settlement process to be executed with confirmation being relayed back to the third party.

Preferably, the method further comprises the steps of:

receiving transaction settlement details; and,

relaying the received transaction settlement details to the third party authorization service.

Thus, the proxy card authentication service will receive the settlement details directly or indirectly from a merchant, for example, and will then relay these directly or indirectly to the third party authorization service. For example, the third party authorization service may be a payment card issuer, in which case the transaction settlement details will typically be relayed to the payment card issuer via the relevant card authority.

Preferably, the authorization rules preconfigured by the first party place a constraint on use of the proxy card or access to the one or more resources in dependence on one or more parameters selected from a group which includes: merchant type or specific merchant identification, a particular time period, the geographical location of second party presenting the proxy card, the amount of a given transaction, and the number of transactions within a time period.

Authorization rules may be configured by the first party to define the way in which a plurality of resources are made available to the second party in response to a request for authorization to access a particular resource. For example, the first party may define a group of payment cards and make use of them accessible to the second party, subject to certain rules. In this way, if a request for payment using a one payment card is refused by the relevant third party authorization service, then the authorization request may be forwarded to the same or another third party authorization service to authorize the use of another payment card in the group for payment. The preconfigured rules would govern the order in which authorization requests for use of the various payment cards should be forwarded.

Preferably, the method further comprises the step of sending the first party a notification that the authorization request has been received. Such notification may be given for each request that is made, or alternatively only for requests that have been refused for some reason. In this way the first party may monitor the attempted use of resources by the second, which is in possession of the proxy card. Notification may be effected through any form of electronic or non-electronic notification or messaging service. Advantageously, notification may be effected by email or SMS.

Of course, as a result of such notification, or for other reasons, the first party may wish to vary the authorization rules.

Preferably, the method further comprises the step of receiving a modification to the preconfigured authorization rules, which govern access to one or more of the available resources by the second party.

In this way, the first party may periodically update authorization rules associated with one or more proxy cards registered with a proxy account, or indeed with other proxy accounts owned by the first party.

According to a third aspect of the present invention a system for governing access by a second party to one or more resources available to a first party comprises:

a storage medium comprising a database which includes details of the resources available to the first party; and

a proxy account server having a processor coupled to the storage medium, the processor adapted to perform the method of the second aspect of the present invention.

Typically, the server will be associated with the proxy card issuer, but may be hosted remotely by another party.

Preferably, the database comprises data relating to a proxy account associated with the proxy card. The proxy account data will generally include data relating to one or more proxy cards registered with that account.

Preferably, the system further comprises a user interface coupled to the processor. The interface allows the first party to interact with his/her proxy account and may be accessible by a wide variety of means, including the internet. Preferably, the processor is adapted to receive and process data input by the user via the user interface. In particular, it is preferred that the processor is adapted to receive data relating to a modification of the authorization rules and to update the rules accordingly.

Preferably, the processor is adapted to present data from the database to the user via the user interface. Preferably, the processor is adapted to send notifications to the user in dependence on transaction data from the database. Notifications may be sent via the user interface or by other means, for example SMS.

Thus, the present invention provides a simple powerful system by which a proxy card authorization service may be provided and which mediates access by a second party to resources available to a first party by means of a proxy card registered with a proxy account and subject to rules preconfigured by the first party. Advantageously, when applied to payment card transactions, the system can act transparently within the normal authorization and settlement process.

### BRIEF DESCRIPTION OF THE DRAWINGS

Examples of the present invention will now be described in detail with reference to the accompanying drawings in which:

FIG. 1 shows a known card authorization and settlement scheme;

FIG. 2 shows a proxy card driven card authorization and settlement scheme according to the present invention;

FIG. 3 shows the hierarchical steps performed during the authorization process for a group of payment cards; and

FIG. 4 illustrates the evaluation of proxy card rules during the authorization process.

### DETAILED DESCRIPTION

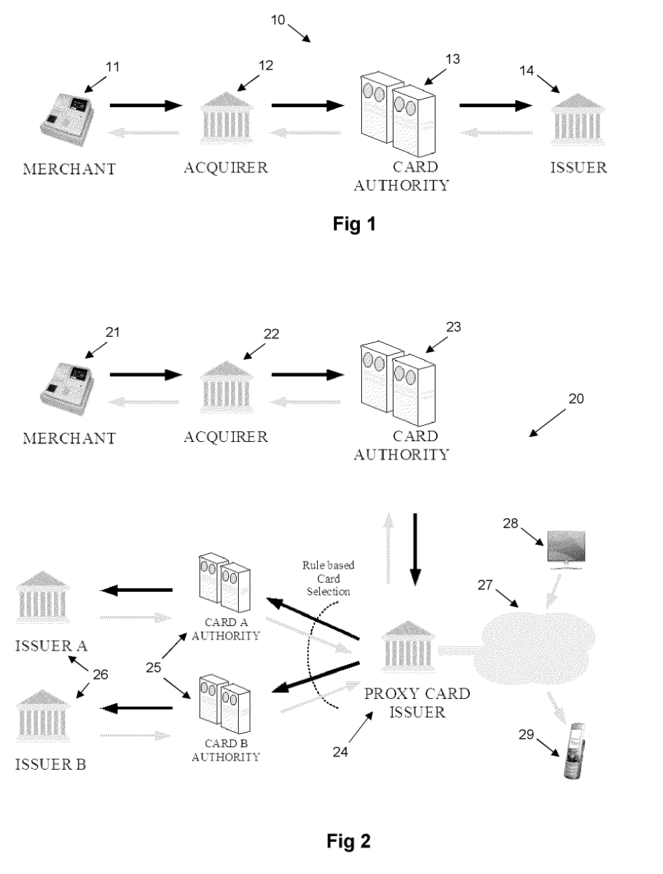

The current state of the art procedure 10 with regard to credit and debit card authorization and transaction settlement is outlined in FIG. 1. A card holder would make use of their card, either in person or through an internet website, to perform a transaction with a Merchant 11. The Merchant 11 would issue an authorization request to their Acquirer 12, who would forward the request to the appropriate Card Authority 13 (e.g. VISA, Mastercard). The card authority is selected based on the appropriate identifying digits of the card account number. The Card Authority 13 would then forward the request to the Card Issuer 14 associated with the card account number.

The result of the authorization procedure performed by the Issuer 14 will be returned to the Merchant 11 via the Card Authority 13 and Acquirer 12. If the authorization was successful, then the Merchant 11 will settle the transaction. This settlement instruction is transferred from the Merchant 11 to its Acquirer 12, which then sends the settlement details to the Issuer 14 via the Card Authority 13. This results in funds being transferred (minus appropriate fees) from the Issuer to the Acquirer which are then placed in the bank account associated with the Merchant 11.

The preferred implementation of the present invention extends the state of the art procedure in a manner 20 as shown in FIG. 2. A proxy card holder would make use of the card, either in person or through an internet website, to perform a transaction with a Merchant 21. The Merchant 21 will send an authorization request via its Acquirer 22 to the Card Authority 23 associated with the proxy card, containing the details of the transaction. This card authority may be an existing organization (e.g. VISA, Mastercard, etc.) or a new authority established specifically for the purpose of supporting the proxy card mechanism.

The Card Authority 23 will then route the authorization request to the Proxy Card Issuer 24, using the same mechanism used with normal card issuers, based on the first group of digits of the account number on the card. Therefore, the Proxy Card Issuer 24 is assuming the role of a card issuer with respect to the proxy card.

When the Proxy Card Issuer 24 receives the authorization request, it will apply the rules (or policy) setup by the account holder. The rules will determine whether the transaction is valid, based on pre-configured constraints. A non-exhausive set of constraint examples are:

a) whether the transaction is within a date/time range,

b) is associated with an approved merchant (i.e. one within the user's list of preferred merchants),

c) frequency of use within a time period,

d) is within a defined geographical area, and/or

e) the transaction amount is within limits.

Any combination of constraints can be combined to express the card account holder's requirements. These constraints will enable the configuration of rules based on any information explicitly available, or derivable, from the authorization request.

If the card account holder has multiple payment cards associated with the proxy card, then the rules will also be used to determine which real payment card (or cards) should be used to handle the transaction.

If the transaction is considered to be invalid, based on the rules established by the card account holder, then the Proxy Card Issuer 24 will return a transaction authorization rejected notification to the Card Authority 23, which will be forwarded to the Merchant 21 (via their Acquirer 22).

If the transaction is considered to be valid, and a real payment card is identified then the Proxy Card Issuer 24 will assume the role of a Merchant and issue a new authorization request to the relevant real Card Authority 25 associated with the real payment card. This may or may not be the same card authority that is associated with the proxy card. The real Card Authority 25 will then forward the real authorization request to the real payment card's Card Issuer 26 for authorization. When the Card Issuer 26 has determined whether the transaction associated with the real payment card is valid, it will return a response via the real Card Authority 25 back to the Proxy Card Issuer 24.

If the real card transaction was successfully authorized, then the transaction associated with the proxy card will also be authorized, returning a successful authorization response back to the Card Authority 23 which will be forwarded to the Merchant 21 via their Acquirer 22.

If the real card transaction was not successfully authorized (e.g. due to lack of funds or credit limit being reached), then there are two possibilities:

(i) No other payment cards are indicated as being valid according to the card account holder's rules, and therefore the Proxy Card Issuer 24 will send an authorization rejected notification back to the Card Authority 23 which will be forwarded to the Merchant 21 via their Acquirer 22.

(ii) Other real payment cards are available, that also meet the card account holder's rules, and therefore the real authorization request will be sent to each of them in turn, until either no card remains (resulting in a transaction rejected notification being returned to the Merchant 21), or a successful authorization request is received (resulting in a transaction authorized notification being returned to the Merchant 21.

If a transaction authorization is successful, then the Merchant 21 will issue the settlement details to their Acquirer 22, which then sends the settlement details to the Proxy Card Issuer 24 via the Card Authority 23. The Proxy Card Issuer 24 then forwards the settlement details to the real Issuer 26 based on cached information regarding which real card was used in respect of the particular transaction. This results in funds being transferred (minus appropriate fees) from the Issuer 26 to the Proxy Card Issuer 24, and subsequently funds transferred (minus appropriate fees) from the Proxy Card Issuer 24 to the Acquirer 22 which are then placed in the bank account associated with the Merchant 21.

The card account holder would have access to their account, registered with the Proxy Card Issuer 24, to perform the following functions:

a) to configure the rules associated with a proxy card, including placing a complete block on all transactions

b) to view the history of authorization requests (both successful and unsuccessful)

c) configure contact details (such as email, sms, and the like).

Access to these services could be provided via any communications mechanism 28, including website and telephone, over the appropriate network 27. The card holder's account can also be configured with rules to govern under what circumstances they should be informed of activities on their account, e.g. notification of failed authorization requests. Notifications could be provided via a range of communication mechanisms 29, including (but not limited to) email and SMS.

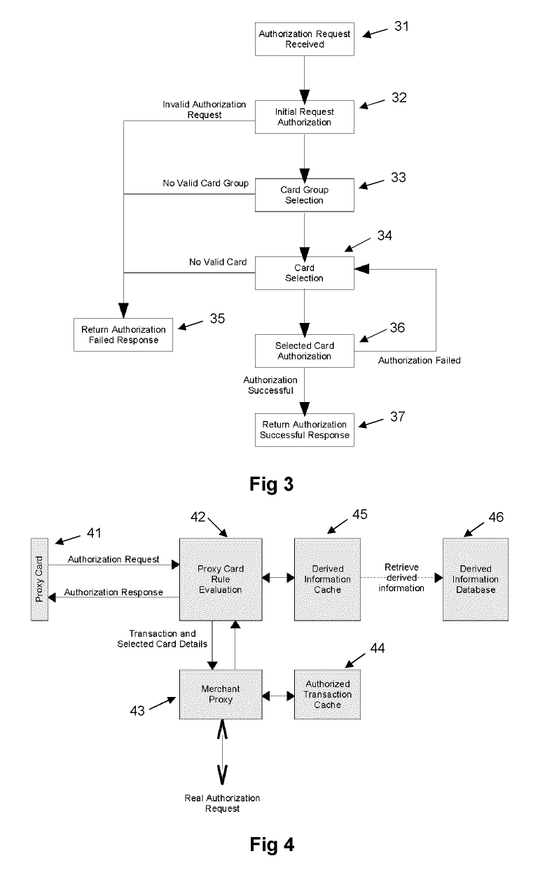

With reference to FIGS. 3 and 4, we now consider in more detail the process flow whereby an authorization request is processed subject to rules configured by the proxy card account holder, including the situation where a number of payment cards are available and where an authorization request may be sent to each card authority in turn subject to the card account holder's rules. The rules enforce constraints pre-specified by the proxy card account holder determine as to whether a request is permissible and so whether an authorization request is sent, and the order in which permissible requests are sent. This system operates as a card issuer for the proxy cards, and as a merchant with respect to the cards it is acting as a proxy for.

The processing steps for a typical situation are as follows:

1. Receive an authorization request for a proxy card transaction.

2. Perform card selection procedure to identify a suitable real card, and issue a real authorization request to the selected card (including commission).

3. If no authorized card is found, then return authorization failed response and finish.

4. If an authorized card is found then cache the card details against a transaction ID.

5. When settlement instructions are received, retrieve the cached card details associated with the transaction ID and send settlement details to the real card issuer (including any commission).

6. When funds are received from the real card issuer, then transfer funds to the merchant (less the commission)

In the above processing steps, the commission refers to the optional fee (or transaction value percentage) that may be charged as remuneration for providing the proxy card service.

FIG. 3 shows the hierarchical steps performed during the authorization process for a group of payment cards. When an authorization request is received 31 it is initially processed 32 by a primary set of authorization rules. This determines if the overall authorization request is acceptable based on the contents of the request, and other information derived from values obtained in the request. If the rules determine that the request is not authorized, then it will immediately be rejected, causing an authorization fault response 35. If the rules determine that the request is authorized, then the request will proceed to card group selection 33.

If only a single card group is defined, and it has no associated rules, then the card group will be selected by default. If rules are defined against the single card group, then the card group will only be selected if the associated rules return a successful result. If multiple card groups are defined, then they will be evaluated in the order they are defined. Each card group must have rules associated with it, to determine if it should be selected. Only the last card group in the list is permitted to not have associated rules, indicating that it should be selected by default.

The card group selection procedure 33 will iterate through the list of available card groups, evaluating their associated rules, until either a card group s rules successfully evaluate (i.e. the group is selected), or there are no further card groups, in which case the authorization request will fail 35. If a card group is selected, whether explicitly by successful evaluation of its associated rules, or by default (i.e. being the only remaining group and having no specified rules), then the next step is to select a card from the group 34.

In the first two steps described above, rules were used to determine whether the request was valid 32 and then which card group should be selected 33. Once a group has been selected then potentially any card defined within the group could be chosen (i.e. all of the cards within the group are considered to be equivalent for the purpose of the type of transaction being performed).

The mechanism used to select the actual card 34 is based on a strategy. There will be a set of predefined strategies that can be used, but it would also be possible to enable further strategies to be added as appropriate. The initial set of strategies could include the following:

(a) Round Robin. In this approach the list of cards within the group is worked through sequentially, returning the next entry in the list. When the end of the list is reached, then it will start again at the beginning. Each new card selection request will continue from the last position within the list. This approach means that transactions will evenly be distributed across all of the cards within the group.

(b) Ordered. In this approach the list of cards are simply worked through in order. When a new authorization request is received, it will begin again at the top of the card list. This approach means that the top card within the list will generally handle all of the transactions until it reaches its limit, at which point the second card will handle all of the transactions, and so on.

(c) Random. In this approach the cards are simply selected at random.

If the card selection strategy fails to find a card (e.g. all cards within a group are used but fail), then this will result in a failed authorization response 35.

Once a card has been selected, then an authorization request will be issued to the card issuer. If the authorization request is successful, then a successful authorization response will be returned for the proxy card 37. If the authorization request is unsuccessful, then the system will return to the Card Selection step 36 to obtain an alternative card. This loop will continue until a successful authorization request is made, or no further cards remain to be selected. With each iteration of this retry loop, the cards that were previously attempted will be excluded from the initial card selection strategy used.

In general, authorization requests will contain some information that can be analyzed directly to determine whether a request associated with a proxy card should be permitted. However, some of the information that the rules require may not be explicitly available within the request. In these situations, it may be possible to derive the necessary information. We now consider, with reference to FIG. 4, how this may be achieved and how access to derived information may be optimized.

When an authorization request associated with a proxy card 41 is received, the information within the request may be combined with additional accessible information 46 to derive new facts upon which user rules 42 can be applied. A simple example is where the derived information is of the merchant type. The request will only carry the merchant ID, but by looking up the information about the merchant (associated with the ID) it would be possible to present the merchant s type as derived information on which to evaluate the authorization request with the proxy card 41.

For example, a rule may state “I want to spend a maximum of $200 at a Supermarket every Tuesday”. To evaluate this rule we need to use the merchant ID to look up the merchant type, for example to determine if they can be classified as a Supermarket. However, performing this type of look up for every request that a user may make will be time consuming. To optimize access to the derived information, when details of this type are retrieved, they will be cached 45 with the user s account. Therefore, the next time a similar transaction is performed, the participant Merchant ID can automatically be classified as a Supermarket.

In order to ensure that cached information does not become out of date, it should be marked with a expiry date/time, at which point the derived fact should be re-evaluated to determine if it is still relevant. In order to also ensure that the user s cached information does not become too large, the cached entries should also be marked with a last used timestamp, so that any entry that has not been accessed within a configured time period could be removed.

During a transaction the Proxy Card Issuer processing the authorization request effectively acts as a proxy 43 for the merchant and forwards the settlement details received from the Merchant (usually indirectly via their acquirer and the card authority) to the real Issuer based on cached information 44 regarding which real card was used in respect of the particular transaction.

The rules mechanism used for the proxy card system will be dependent upon the complexity required. The rule functionality would typically be implemented as a pluggable component that could be configured with a set of rules in an appropriate format, and that could be supplied with an authorization request and have access to additional reference data which can be used to derive other facts related to the request.

When an authorization request is processed, whether successful or unsuccessful, the information regarding the evaluations that were performed, and the results that occurred at each stage of the authorization procedure will be logged for audit purposes. This information can then be used for the purpose of determining whether invalid authorization attempts were being made, or why authorization requests that were expected to succeed have actually failed. This enables the account owner to modify the rules accordingly to meet their requirements.

When an authorization request is being processed, a notification mechanism will be used to inform the account owner of different situations that may occur with the processing of the request. It will be possible for the account owner to configure the specific situations they are interested in, which may include the following:

an authorization request has been processed successfully.

an authorization request has failed to be processed (including a reason, such as failed initial rules, unable to find card group, unable to find appropriate card in group, and so on).

authorized transaction has been settled.

The notification could be delivered to the account owner via a number of different channels, including SMS and email.

It should be appreciated that a proxy card according to the present invention could be used in situations where proof is required that a second party is acting as a legal proxy on behalf of a first party. The invention would operate in a similar manner to that described above, the difference being that the transaction authorization by the proxy card would not need to be forward to any other card associated with that user.

In this scenario, the proxy card would act as proof that the party presenting the card (i.e., the second party) had the proxy of the card owner (i.e. the first party), but it would not vouch for the identity of the card owner. Therefore, this use of the proxy card would require an additional feature, which would be that the proxy card issuer would enable the organization checking the identity of the proxy card owner to access details associated with the proxy card account number, which can be used to verify the identity of the “real” user. Such details could include: full name, address, date of birth, social security number, and the like.

1. A proxy card associated with a proxy account, the proxy account comprising details of one or more resources to which a first party has access, wherein access to one or more of the resources by a second party is granted in dependence on the proxy card and is governed by authorization rules, the rules being preconfigured by the first party.

2. The proxy card according to claim 1, wherein the proxy card has an associated card number.

3. The proxy card according to claim 1, wherein the resources comprise one or more bank account or credit card account in the name of the first party.

4. The proxy card according to claim 3, wherein the preconfigured rules include rules to govern how specific transactions are routed to payment cards associated with one or more of the bank accounts or credit card accounts.

5. The proxy card according to claim 1, wherein the authorization rules preconfigured by the first party include rules to constrain access to one or more of the resources by the second party in dependence on one or more parameters selected from a group which includes: a merchant type, a specific merchant identification, a time period, a geographical location of the second party presenting the proxy card, an amount of a given transaction, and a number of transactions occurring within a time period.

6. The proxy card according to claim 1, wherein the preconfigured rules include rules to constrain the circumstances under which the second party has the legal proxy of the first party and may act accordingly.

7. The proxy card according to claim 1, wherein the preconfigured authorization rules may be modified by the first party.

8. The proxy card according to claim 1, wherein the first party and the second party are the same party.

9. A method for governing access by a second party to one or more resources available to a first party comprising the steps of:
receiving a request for authorization to access the one or more resources in dependence on a proxy card;
determining whether the one or more resources are associated with the proxy card;
applying authorization rules to determine whether access to the one or more resources should be granted, the rules having been preconfigured by the first party; and,
transmitting a reply indicating whether authorization to access the one or more resources has been granted.

10. The method according to claim 9, wherein the method further comprises the step of associating the proxy card with a proxy account in the name of the first party.

11. The method according to claim 9, wherein the method further comprises the step of authenticating the first party.

12. The method according to claim 11, wherein the first party is authenticated in dependence on one or more personal details selected from a group which includes: full name, address, date of birth, and social security number.

13. The method according to claim 11, wherein the first party is authenticated on receipt of a request from a merchant or vendor made in response to the merchant or vendor being presented with the proxy card or associated details by the second party.

14. The method according to claim 13, wherein the request is a payment authorization request to facilitate payment for goods or services purchased by the second party, and wherein payment is debited to a payment account in the name of the first party.

15. The method according to claim 9, wherein the method further comprises the step of authenticating the second party.

16. The method according to claim 15, wherein the second party is authenticated in dependence on data associated with the first party.

17. The method according to claim 9, wherein the method further comprises the step of deriving information from the received authorization request in dependence on stored information and applying the authorization rules in dependence on this derived information.

18. The method according to claim 17, wherein the method further comprises the step of storing the derived information in a cache.

19. The method according to claim 9, wherein the first party and the second party are the same party.

20. The method according to claim 9, wherein the method further comprises the steps of:
forwarding the received authorization request to a third party authorization service; and,
receiving from the third party authorization service a reply indicating whether authorization to access at least one of the resources has been granted,
wherein the step of transmitting a reply indicating whether authorization to access the one or more resources has been granted is performed in dependence on the reply received from the third party authorization service.

21. The method according to claim 20, wherein the resource to be accessed is a payment account and the third party authorization service is provided by a card authority or card issuer associated with a payment card for the payment account.

22. The method according to claim 20, wherein the method further comprises the steps of:
receiving transaction settlement details; and,
relaying the received transaction settlement details to the third party authorization service.

23. The method according to claim 20, wherein the rules preconfigured by the first party include rules to constrain access to one or more of the resources by the second party in dependence on one or more parameters selected from a group which includes: a merchant type, a specific merchant identification, a time period, a geographical location of the second party presenting the proxy card, an amount of a given transaction, and a number of transactions occurring within a time period.

24. The method according to claim 20, wherein the rules preconfigured by the first party include rules to govern access by the second party to a plurality of the resources in response to a request for authorization to access one of the plurality of resources.

25. The method according to claim 24, wherein the plurality of resources are a plurality of payment accounts and the preconfigured rules govern the order in which authorization requests for use of payment cards associated with the payment accounts should be forwarded to one or more third party authorization services.

26. The method according to claim 9, wherein the method further comprises the step of sending the first party a notification that the authorization request has been received.

27. The method according to claim 26, wherein the notification is sent by email or SMS.

28. The method according to claim 9, wherein the method further comprises the step of receiving data relating to a modification to the preconfigured authorization rules and updating the rules accordingly.

29. A system for governing access by a second party to one or more resources available to a first party comprising:
a storage medium comprising a database which includes details of the resources available to the first party; and,
a proxy account server having a processor coupled to the storage medium, the processor adapted to perform the steps of:
receiving a request for authorization to access the one or more resources in dependence on a proxy card;
determining whether the one or more resources are associated with the proxy card;
applying authorization rules to determine whether access to the one or more resources should be granted, the rules having been preconfigured by the first party; and,
transmitting a reply indicating whether authorization to access the one or more resources has been granted.

30. The system according to claim 29, wherein the server is associated with an issuer of the proxy card.

31. The system according to claim 29, wherein the database comprises data relating to a proxy account associated with the proxy card.

32. The system according to claim 31, wherein the proxy account data includes data relating to one or more proxy cards registered with the proxy account.

33. The system according to claim 29, wherein authorization rule functionality is implemented as a pluggable component that is configurable with a set of rules.

34. The system according to claim 29, wherein the processor is further adapted to receive data relating to a modification of the authorization rules and to update the rules accordingly.

35. The system according to claim 29, wherein the processor is further adapted to derive information from the authorization request in dependence on stored information and to apply the authorization rules in dependence on the derived information.

36. The system according to claim 35, wherein the proxy account server further comprises a cache for storing the derived information.

37. The system according to claim 29, wherein the system further comprises a user interface coupled to the processor and wherein the processor is adapted to receive and process data input by the user via the user interface.

38. The system according to claim 37, wherein the user interface is accessible via the internet.

39. The system according to claim 37, wherein the processor is further adapted to present data from the database to the user via the user interface.

40. The system according to claim 37, wherein the processor is further adapted to send notifications to the user interface in dependence on transaction data from the database.

41. The system according to claim 29, wherein the processor is further adapted to send notifications to the user in dependence on transaction data from the database.

42. The system according to claim 41, wherein the notifications are sent by email or SMS.
